(19) United States
(12) Patent Application Publication
(10) Pub. No.: US 2010/0235207 A1
(43) Pub. Date: Sep. 16, 2010

(54) SYSTEM FOR INTEGRATING POS SYSTEM AND BUILDING MANAGEMENT SYSTEM

(76) Inventor: Tomohiro ASAZUMA, Kawagoe-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/687,495

(22) Filed: Jan. 14, 2010

(30) Foreign Application Priority Data
Mar. 13, 2009 (JP) 2009-061651

(51) Int. Cl. G06Q 10/00

(52) U.S. Cl. 705/7; 705/22; 705/30

(57) ABSTRACT

According to one embodiment, there is provided a system integrating a POS system and a central management system in a building that houses many shops. A POS server performs an accounts calculation for each shop, using the POS data input from POS terminals and the variable expense data items transmitted from a POS interface unit.

### CROSS-REFERENCE TO RELATED APPLICATIONS

This application is based upon and claims the benefit of priority from prior Japanese Patent Application No. 2009-061651, filed Mar. 13, 2009, the entire contents of which are incorporated herein by reference.

### BACKGROUND OF THE INVENTION

1. Field of the Invention

The present invention relates to a system for managing a building that houses, for example, a plurality of shops. More particularly, the invention relates to a system that integrates a POS system and a building management system.

2. Description of the Related Art

A large building, such as a shopping center or a department store, houses a plurality of shops as tenants in most cases. In recent years, point-of-sales (POS) systems designed to manage the sales amounts at various shops is installed in such buildings. (See, for example, Jpn. Pat. Appln. KOKAI Publications Nos. 2004-185112 and 2007-207170.) The POS system comprises a server and POS terminals. The POS terminals are installed in each of the shops. The server, which is owned by the building owner, collects POS data (i.e., sales data) from the POS terminals. Sales management is performed on the basis of the POS data thus collected.

The building has a building management system, too. The building management system monitors the consumption of electricity, gas and water in each shop (e.g., electricity the air conditioners consume in each shop). (See, for example, Jpn. Pat. Appln. KOKAI Publication No. 2003-141217.) Hitherto, the building management system and the POS system were not linked, and operated independently of each other. A system that can manage the sales amount together with the electricity charge, gas charge and water charge in each shop is not easy to design and build. Further, a high cost is involved in using and running such a system, because the system needs many input devices and must collect and process a huge amount of data coming from many POS systems.

Shop management systems have been proposed, which can display data from which to monitor the energy consumption in each shop. (See, for example, Jpn. Pat. Appln. KOKAI Publication No. 2006-178886.) The shop management system is inked with the POS system installed in the building. However, it is designed only to save energy.

As described above, a shopping center or a department store has a POS system and a building management system, which operate independently of each other. The POS system and the building management system may be linked to integrate the sales management and the expense (e.g., energy charge) management for each shop. However, such an integrated system will require a high running cost.

### BRIEF SUMMARY OF THE INVENTION

An object of this invention is to integrate a POS system and a building management system, or to provide an integrated system that can perform both sales management and expense management at low cost, for each of the shops housed in a building.

According to an aspect of the invention, there is provided an integrated management system composed of a POS system and a building management system, which is suitable for use in any building housing a plurality of shops.

A system according to an aspect of this invention comprises: a terminal unit configured to input sales data about each merchandize item sold in each shop; a management unit configured to calculate variable expenses at the shop, including an expense on energy used to run the shop; and a server connected to the terminal unit and the management unit by a network and configured to perform a designated accounts calculation for each shop, by using the sales data and the variable expenses.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the major components of a system according to an embodiment of this invention;

FIG. 2 is a diagram explaining how the system according to the embodiment operates; and

FIG. 3 is a diagram explaining how a modified system according to the embodiment operates.

### DETAILED DESCRIPTION OF THE INVENTION

An embodiment of the present invention will be described, with reference to the accompanying drawings.

### (Configuration of the System)

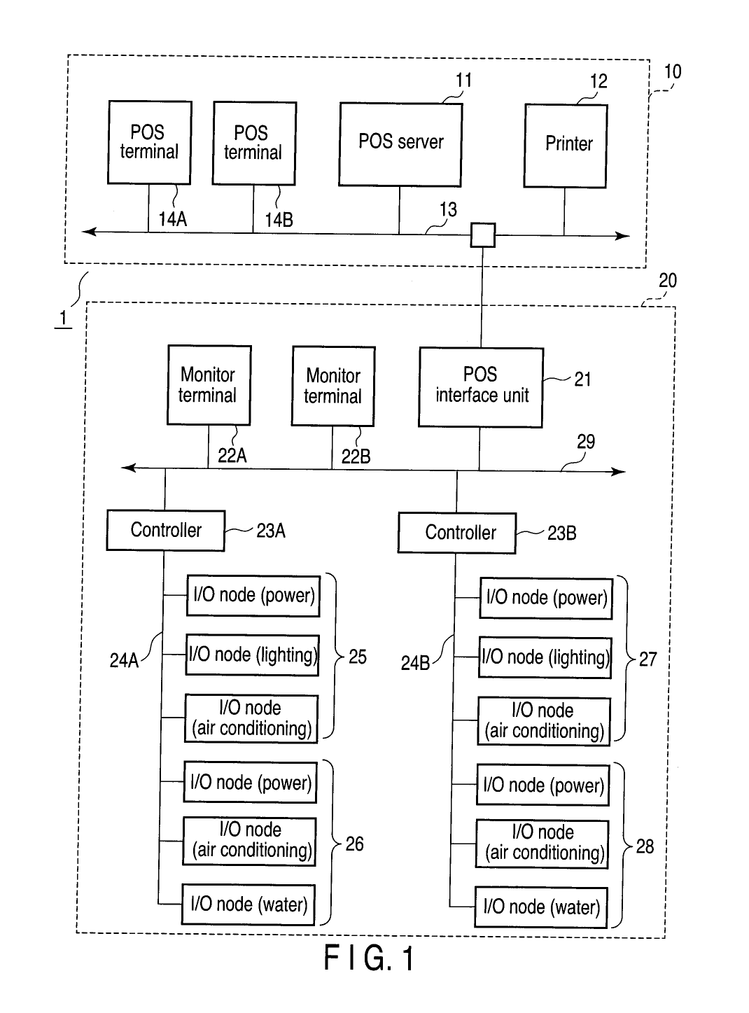

FIG. 1 is a block diagram showing the major components of system 1 according to the embodiment.

System 1 is an integrated system designed for use in a shopping center or a department store, which houses a plurality of shops as tenants. System 1 comprises a point-of-sales (POS) system 10 and a central management system 20. The central management system 20 is equivalent to a building management system.

The POS system 10 has a POS server 11, a printer 12, a local area network (hereinafter called LAN) 13, and POS terminals 14A and 14B. The POS server 11 collects sales data (data about any merchandize item sold), performs an accounts calculation (i.e., sales amount calculation) calculates sales amounts and performs a process of issuing bills. The printer 12 prints bills in accordance with the bill data processed by the POS server 11.

The LAN 13 connects the POS server 11, printer 12 and POS terminals 14A and 14B to one another. Various items of data can therefore be supplied between the POS server 11, printer 12 and POS terminals 14A and 14B. The POS terminals 14A and 14B are installed in the respective shops (two shops in this embodiment) housed in a building. When operated by sales clerks in the shops, the POS terminals 14A and 14B input POS data items. The POS data items thus input are transmitted to the POS server 11 through the LAN 13.

The central management system 20 has a POS interface unit 21, monitor terminals 22A and 22B, controllers 23A and 23B, control-system LANs 24A and 24B, input/output (I/O) node groups 25 to 28, and a monitor-system LAN 29.

The POS interface unit 21 connects the LAN 13 and the monitor-system LAN 29, working as an interface that transmits data between the POS system 10 and the central management system 20. The POS interface unit 21 includes a computer that calculate the electricity consumption (including electricity used in air conditioners), tap water, and gas in each shop, as will be described later.

The monitor terminals 22A and 22B display measured values (i.e., electricity consumed, water used, usage time of each air conditioner, etc.) transmitted from the controllers 23A and 23B, and cause the controllers 23A and 23B to control the air conditioners and the like. The controllers 23A and 23B acquire the measured values and transmit them to the POS interface unit 21 and the monitor terminals 22A and 22B through the monitor-system LAN 29.

The controllers 23A are connected by the control-system LAN 24A to the I/O node groups 25 and 26. Similarly, the controllers 23b are connected by the control-system LAN 24B to the I/O node groups 27 and 28. The I/O node groups 25 and 27 each consist of three nodes configured to output control signals and input alarm signals, respectively, to and from the power device, illumination device and air conditioner installed in each shop. The I/O node groups 26 and 28 each consist of three nodes configured to receive the measured values from the three meters installed in each shop, the meters being configured to measure the lighting power, air-conditioning power and water amount used, and transmit these measured values to the controllers 23A and 23B.

### (Operation of the System)

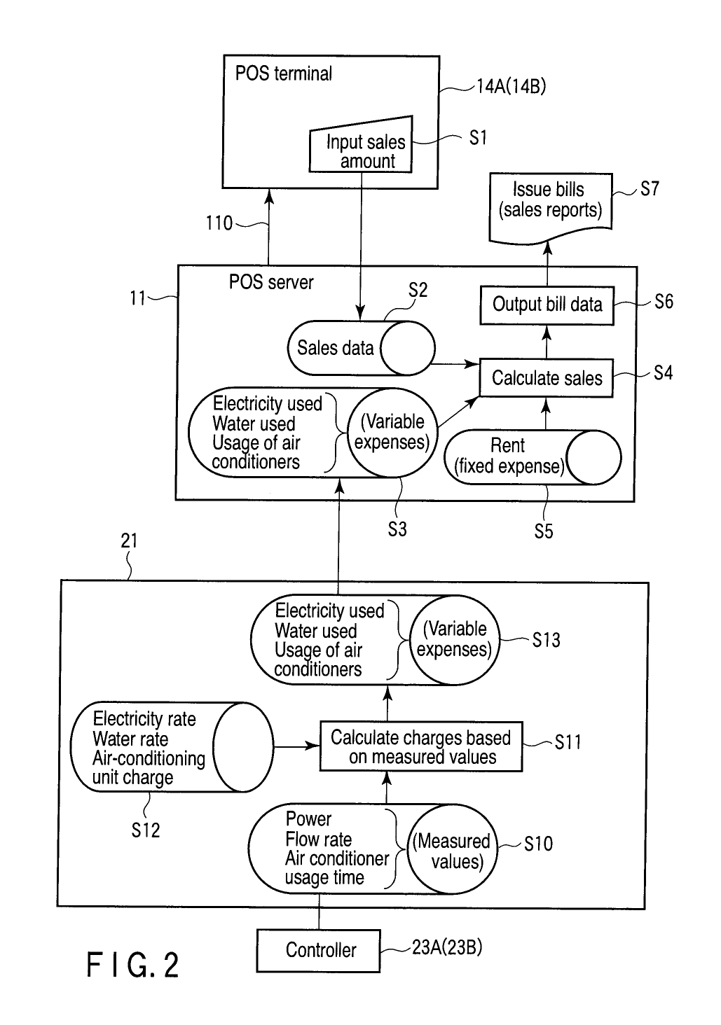

How the system 1 according to this embodiment operates will be explained with reference to FIG. 2.

In the POS system 10, the POS terminals 14A and 14B installed in two shops, respectively, input POS data items (i.e., sales data items for respective merchandize items sold). The POS data items are transmitted through the LAN 13 to the POS server 11 (Step S1). The POS server 11 incorporates a storage device, which saves the POS data (data items representing the sales amounts at the two shops) (Step S2).

The POS server 11 performs an accounts calculation (i.e., sales amount calculation) on the basis of the sales data input from the POS terminals 14A and 14B, the variable expense data (later described) and the fixed expense data (Step S4). The variable expense data is transmitted from the POS interface unit 21. The fixed expense data, including the rent paid by the shop owners, is acquired from the master file stored in the storage device (Step S5).

That is, the POS server 11 performs the calculation (net sales=total sales−fixed expense−total variable expense). In other words, the POS server 11 calculates the net sales of each shop (tenant) (Step S4). The “total sales” is, for example, the monthly sales at the shop, input at the POS terminals 14A and 14B installed in the shop. The “fixed expense” is, for example, the monthly rent. The “total variable expense” is the sum of the monthly electricity charge, monthly water charge and monthly air-conditioner use charge.

The POS server 11 performs a process of issuing bills (sales reports) stating the sales amount (net sales) for the respective shops (Step S6). That is, the bill data is supplied to the printer 12, which prints bills (sales reports). The bills thus printed are distributed to the shops (Step S7). Alternatively, the POS server 11 may transmit the bill data (sales report data) 110 to the POS terminals 14A and 14B installed in the shop. In this case, the POS terminals 14A and 14B display the bill (sales report) on their screens. Seeing the bill data 110 thus displayed, the shop manager can confirm the monthly sales (net sales), the monthly fixed expense (i.e., monthly rent) and the monthly total variable expense (i.e., sum of the electricity, water and air-conditioner use charges).

The POS interface unit 21 calculates the total variable cost that must be used to calculate the net sales and transmits the data representing this cost to the POS server 11 (Step S13). The POS interface unit 21 collects various values measured at each shop (i.e., electricity consumed, water used and air-conditioner usage time), from the controllers 23A and 23B installed at each shop (Step S10). The POS interface unit 21 uses the formula stored in a storage device, calculating the electricity charge, water charge and air-conditioner use charge on the basis of the measured values (Step S11).

More specifically, the POS interface unit 21 acquires the data representing the electricity rate, water rate and air-conditioning unit charge (Step S12). The POS interface unit 21 uses this data and the formula (i.e., electricity charge=electricity consumed×electricity rate; water charge=water consumed×water rate; and air-conditioning charge=usage hours×air-conditioning unit charge), thereby calculating the monthly electricity charge, monthly water charge and monthly air-conditioning charge for each shop (Step S13).

Thus, the embodiment can constitute system 1, which integrates the POS system 10 and the central management system 20. System 1 can therefore issue bills (sales reports) showing the sales amount and charges (both fixed expense and variable expense) to all shops housed in, for example, a shopping center or a department store.

Use of system 1 makes it unnecessary to input the amount of electricity used, the amount of water used or the hours of using the air conditioners in each of the shops. The efficiency of inputting data in the system is therefore high. Further, the system 1 can automatically issue bills (sales reports) to the shops. This can reduce the running cost of system 1. Moreover, data need not be input at the POS system 10 or the central management system 20, because all data necessary is input at the POS terminals installed in the shops. The cost of running the entire system 1 can therefore be reduced.

The embodiment described above is a system that integrates the POS system 10 and the central management system 20 provided in the building. Nevertheless, the present invention is not limited to the embodiment. The invention can be applied to a system that integrates the POS system 10 and a measuring system such as an outdoors data-transmitting apparatus (i.e., telemeter apparatus), as will be described below.

### (Modified System)

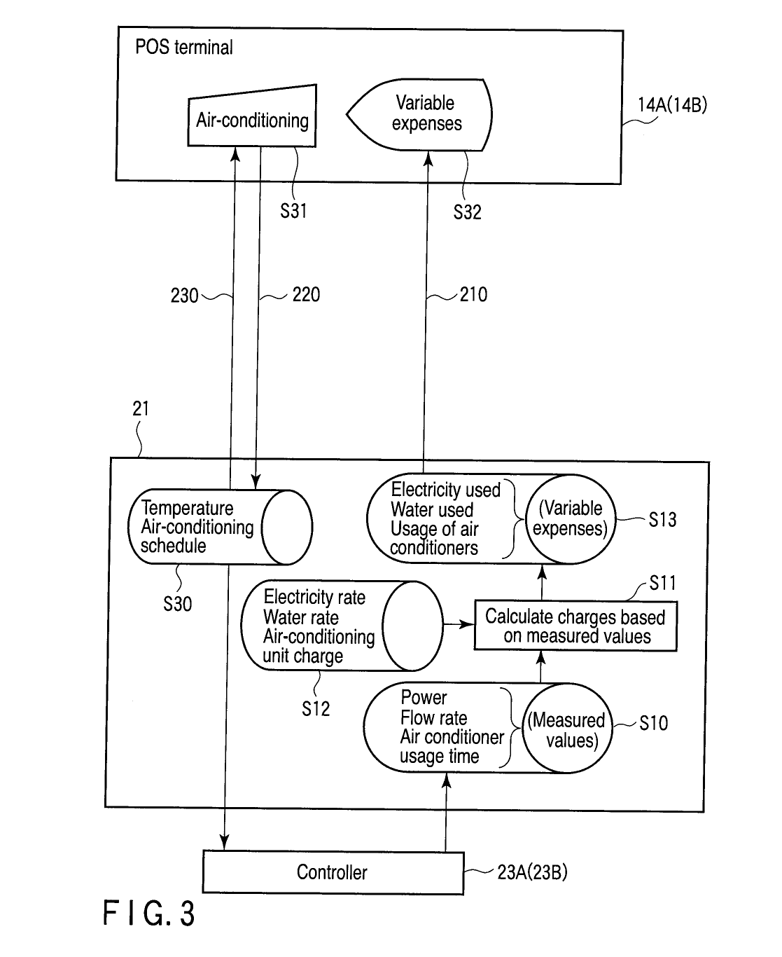

FIG. 3 is a diagram showing a modification of the system 1. The modified system is similar in configuration to system 1 shown in FIG. 1. The components of the modified system, which are identical to those shown in FIG. 1, will not be described.

As can be understood from in FIG. 3, the POS interface unit 21 collects various values measured at each shop (i.e., electricity consumed, water used and air-conditioner usage time), from the controllers 23A and 23B installed at each shop (Step S10). The POS interface unit 21 uses the formula stored in a storage device, calculating the electricity charge, water charge and air-conditioner use charge on the basis of the measured values (Step S11). At this point, the POS interface unit 21 acquires the data representing the electricity rate, water rate and air-conditioning unit charge (Step S12), from the master file stored in the storage device (Step S12).

The POS interface unit 21 uses this data and the formula (i.e., electricity charge=electricity consumed×electricity rate; water charge=water consumed×water rate; and air-conditioning charge=use hours×air-conditioning unit charge), thereby calculating the electricity charge, water charge and air-conditioning charge for each shop (Step S13).

The POS interface unit 21 transmits the data 210 representing the electricity charge, water charge and air-conditioning charge to the POS terminals 14A and 14B installed in the shop. In this case, the POS terminals 14A and 14B display the bill (sales report) on their screens in real time (Step S32). Seeing the bill data 210 thus displayed, the shop manager can confirm the monthly sales (net sales) and the monthly total variable expense (i.e., sum of the electricity, water and air-conditioner use charges).

The POS interface unit 21 also supplies data 230 to the POS terminals 14A and 14B. This data 230 represents a menu for setting the operating conditions of air conditioners (i.e., temperature and schedule). The POS terminals 14A and 14B display this menu on their display screens (Step S31). The POS terminal 14A or 14B may supply data that represents the change in the operating conditions of air-conditioners (for example, a temperature change and an extension of air-conditioning time) to the POS interface unit 21. On receiving this data, the POS interface unit 21 performs a process of changing the operating conditions of the air conditioners (i.e., temperature and schedule) (Step S30). In other words, the POS interface unit 21 causes the controllers 23A and 23B associated with the POS terminals 14A and 14B to control the air conditioners installed in the shop in accordance with the changes in the operating conditions of the air conditioners.

The modified system described above is thus an integrated system 1 that integrates the POS system 10 and the central management system 20. In this integrated system, the POS terminals 14A and 14B installed in each shop (tenant) housed in a building such as a shopping center or a department store can display the total variable expense (i.e., sum of the electricity, water and air-conditioner use charges) on their screens in real time. Seeing the data thus displayed, the shop manager can confirm the electricity, water and air-conditioner use charges, and can then take measures to reduce the variable expense.

Moreover, the air conditioners installed in each shop can be directly controlled at the POS terminals 14A and 14B installed in the shop. The air conditioners may be finely controlled in each shop, to reduce the variable expense in the shop, and ultimately to save energy. The manager of any small shop (or small-business tenant) that cannot afford a dedicated terminal for setting the operating conditions of air conditioners cannot finely control the air conditioners, because he or she cannot know how much power the air conditioners have consumed, until the end of the month when he or her receives the electricity bill, water bill and air-conditioner use bill. This problem is solved by operating the POS terminals 14A and 14B installed in the shop.

In the system 1 of FIG. 1 or the modified system of FIG. 3, the POS terminals 14A and 14B may display the bills (sales reports) or the variable expense, for example in the form of real-time graphs.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A system comprising:
a terminal unit configured to input sales data about each merchandize item sold in each shop;
a management unit configured to calculate variable expenses at the shop, including expense on energy used to run the shop; and
a server connected to the terminal unit and the management unit by a network and configured to perform a designed accounts calculation for each shop, by using the sales data and the variable expenses.

2. The system according to claim 1, wherein the server calculates the sales amount at each shop, from the sales data about each merchandize item, and performs an accounts calculation of finding the variable expenses at the shop.

3. The system according to claim 2, wherein the server performs an accounts calculation of subtracting the variable expenses and the rent from the sales amount, thereby calculating a bill amount.

4. The system according to claim 1, wherein the management unit has a measuring unit configured to measure amounts of electricity, gas and water consumed in the shop, and calculates the variable expenses at the shop, from the amounts of electricity, gas and water, which have been measured by the measuring unit.

5. The system according to claim 1, further comprising a printer configured to print data output from the server,
wherein the sever supplies a result of the accounts calculation to the printer, and the printer prints the result of the accounts calculation.

6. The system according to claim 1, wherein the server transmits a result of the accounts calculation to the terminal unit through the network.

7. The system according to claim 1, wherein the management unit comprises an interface unit connected to the server by the network and configured to exchange data with the server, and a controller configured to collect measured value data generated by a measuring unit and representing amounts of electricity, gas and water consumed in the shop, and to transmit the measured value data to the interface unit; and the interface unit calculates variable expenses at each shop, from the data transmitted from the measured value data, and transmits data representing the variable expenses to the server.

8. The system according to claim 1, wherein the management unit transmits data representing the variable expenses to the terminal unit, thereby to display the variable expenses on a display screen included in the terminal unit.

9. The system according to claim 1, wherein the management unit receives control data transmitted from the terminal unit and representing operating conditions of air conditioners, and controls the air conditioners installed in the shop having the terminal unit, in accordance with the control data.

10. A system for integrating a POS system and a building management system, comprising:
a POS terminal unit installed in each shop and configured to input sales data about each merchandize item sold;
a management unit configured to calculate variable expenses at the shop, including expense on energy used to run the shop; and
a server connected to the POS terminal unit and the management unit and configured to exchange various data with the POS terminal and the management unit,
wherein the server acquires a sales amount from the sales data input from the POS terminal unit, data representing the variable expenses from the management unit, and fixed expense including rent, from a file stored, and performs an accounts calculation of subtracting the variable expenses and the fixed expense from the sales amount, thereby calculating a net sales at the shop.

11. A method of integrating a POS system and a building management system, comprising:
acquiring sales data about each merchandize item, from each terminal unit installed in each of the shops housed in a building;
monitoring electricity, gas and water used in the building and calculating amounts of electricity, gas and water consumed in each shop; and
performing a designed accounts calculation for each shop, by using the sales data and the amounts of electricity, gas and water consumed.
